(19) United States
(12) Patent Application Publication
(10) Pub. No.: US 2017/0217278 A1
(43) Pub. Date: Aug. 3, 2017

(54) AIR CONDITIONING SYSTEM FOR CONDITIONING AIR IN AUTOMOBILE PASSENGER COMPARTMENT

(71) Applicant: Hanon Systems, Daejeon (KR)

(72) Inventors: Gerald Richter, Aachen (DE); Marc Graaf, Krefeld (DE); Julia Roeb, Koln (DE); Toni Spies, Koln (DE)

(73) Assignee: Hanon Systems, Daejeon (KR)

(21) Appl. No.: 15/501,466

(22) PCT Filed: Oct. 23, 2015
(86) PCT No.: PCT/KR2015/011258

§ 371 Date: Feb. 3, 2017

(30) Foreign Application Priority Data
Oct. 24, 2014 (DE) 102014115496.7
Oct. 21, 2015 (DE) 102015117962.8

(51) Int. Cl. B60H 1/00; B60H 3/02

(52) U.S. Cl. CPC B60H 1/00064; B60H 1/00921; B60H 3/024; B60H 2001/00128; B60H 2001/00092; B60H 2001/00099; B60H 2001/00178; B60H 2001/00949

(57) ABSTRACT

An air-conditioning system for conditioning air in a vehicle passenger compartment including a housing having a first flow channel and a second flow channel for guiding air, and a refrigerant circulation system having at least two heat exchangers. An air guide device is disposed between the evaporator and the passenger compartment in the first flow channel, and an air guide device is disposed between the condenser/gas cooler and the passenger compartment in the second flow channel. The air guide device disposed in the first flow channel consists of multiple parts such as at least two members, and the members are respectively assigned to air channels extending to the passenger compartment, are independently controllable, and are movable so as to open or close the respective air channels.

### CROSS-REFERENCE TO RELATED PATENT APPLICATIONS

This patent application is a United States national phase patent application based on PCT/KR2015/011258 filed Oct. 23, 2015, which claims the benefit of German Patent Application No. 10-2015-117962.8 filed Oct. 21, 2015 and German Patent Application No. 10-2014-115496.7 filed Oct. 24, 2014, the disclosures of which are hereby incorporated herein by reference in their entirety.

### TECHNICAL FIELD

The present invention relates to an air-conditioning system for conditioning air in a vehicle passenger compartment. The air-conditioning system is configured to operate in a cooling system mode for cooling air to be supplied to the passenger compartment and in a heat pump mode for heating the same, and to operate in a reheating mode. The air-conditioning system includes a housing having first and second flow channels for guiding air, and a refrigerant circulation system having at least two heat exchangers. In this case, a first heat exchanger, which operates as an evaporator regardless of the operating mode, is disposed in the first flow channel, and a second heat exchanger, which operates as a condenser regardless of the operating mode, is disposed in the second flow channel. Moreover, air guide devices are arranged in the first and second flow channels. The present invention also relates to a method of operating the air-conditioning system.

### BACKGROUND ART

Air-conditioning systems for vehicles, configured to operate in both a cooling system mode and a heat pump mode for heating, cooling, and dehumidifying air which will be supplied to a passenger compartment and be conditioned therein, are known in the related art. Such air conditioners are controlled at the refrigerant circulation system side or air side thereof.

Conventional air side-controlled compact air-conditioning systems having heat pump functions include a structurally simple refrigerant circulation system which has an evaporator, a compressor, a condenser/gas cooler, and an expansion member. In this case, the evaporator is operated as an evaporator in both a cooling system mode and a heat pump mode, and the condenser is also operated as a condenser in both the cooling system mode and the heat pump mode. In this regard, heat flows are completely controlled through air-side flow control. Heating, cooling, and dehumidification functions allow air, which will be supplied to a passenger compartment, to be provided at any mixing temperature by interconnecting the air sides of air-conditioning systems so as to be suitable for the purpose. In this case, the air flow, which excessively flows in the condenser, as a hot-air flow may be mixed, as needed, with the air flow, which excessively flows in the evaporator, as a cold-air flow, so as to be adapted for a required blowing air temperature. The mixed air flow is guided to the passenger compartment through flow channels. The air flow is guided to corresponding discharge ports, such as at least one discharge port on a windshield (front window), discharge ports for directly blowing air to occupants, and discharge ports communicating with legroom, by an air distribution system which has various discharge control members and is disposed in the vehicle. Excess air is discharged to the outside through additional discharge ports from the housing of the compact air-conditioning system.

FR 2 743 027 A1 discloses an air conditioner for vehicles, which includes a conventional refrigerant circulation system having only an evaporator, a compressor, a condenser, and an expansion member. Heat exchangers are disposed within separate flow channels in the form of at least fluid separation. The flow channels have cross connections or bypasses. The air mass flows introduced by blowers are guided by the closing and opening of flaps and through the surfaces of the heat exchangers by passing through the bypasses according to operating modes if necessary. In this case, the air mass flows are cooled and/or dehumidified or heated, and are then discharged to a passenger compartment and/or to the outside.

DE 10 2011 052 752 A1 discloses a modular air conditioner for vehicles, which has a heat pump function for heating and cooling air. The air conditioner for vehicles includes a housing, which has a blower and flaps for adjusting air flow paths, and a refrigerant circulation system which has a condenser, an evaporator, an expansion member, and associated connection lines. An evaporator-air flow path with an integrated evaporator and a condenser-air flow path with an integrated condenser are formed in the housing. The two air flow paths are connected to each other through the controllable flaps such that a passenger compartment is heated and cooled only through the adjustment of the air flow paths.

DE 10 2012 108 891 A1 discloses an air-conditioning system for conditioning air in a passenger compartment. The air-conditioning system includes a housing having first and second flow channels for guiding air, and a refrigerant circulation system having an evaporator and a condenser. The evaporator is disposed in the first flow channel, and the condenser is disposed in the second flow channel. In this case, at least one heat exchanger, i.e. the evaporator or the condenser, from among the heat exchangers, is configured such that a portion of the heat transfer surface thereof is disposed in both the first flow channel and the second flow channel. The ratio of the heat transfer surface required for each operating mode may be adjusted in such a manner that air is supplied to the heat transfer surface by air guide devices.

The air-conditioning systems known in the related art are characterized in that air guided to the passenger compartment is mixed from various air flows to have a mixing temperature. The air-conditioning systems are referred to as single-zone air-conditioning systems. As a result, air having a uniform temperature is supplied to the air distribution system disposed in the vehicle, and the flows of air introduced to the passenger compartment from all of the opened discharge ports is discharged at the same temperature. Moreover, the air-conditioning systems installed in the vehicle make it possible to individually set a target air temperature value for different zones in the passenger compartment, such as a driver seat, a passenger seat, a back seat, or each individual seat. Therefore, for the use of a multi-zone air-conditioning system, it is necessary to individually adjust at least a temperature in individual zones. The individual temperature adjustment may not be realized by the flow rate of air discharged from all of discharge ports having a uniform temperature in the single-zone air-conditioning system.

### SUMMARY OF THE DISCLOSURE

Accordingly, the present invention has been made in view of the above-mentioned problem, and an object thereof is to provide an air side-controlled compact air-conditioning system that has a heat pump function for heating, cooling, and/or dehumidifying air, in particular for application to vehicles. In order to provide flows of air, having a correspondingly adjusted temperature, to individual zones by the air-conditioning system, the temperatures of the respective flows of air, guided to various zones in a passenger compartment through a large number of discharge ports, must be adjusted. The air-conditioning system, in particular a refrigerant circulation system, should have only the minimum number of parts, and should be economically manufactured at low cost and have no defect.

In accordance with an aspect of the present invention, the above and other objects can be accomplished by the provision of an air-conditioning system for conditioning air in a vehicle passenger compartment. The air-conditioning system is configured to operate in a cooling system mode for cooling air to be supplied to the passenger compartment and in a heat pump mode for heating the same, and to operate in a reheating mode, and includes a housing having a first flow channel and a second flow channel for guiding air communicating with the passenger compartment, and a refrigerant circulation system having at least two heat exchangers. In this case, the first heat exchanger is disposed in the first flow channel, and the second heat exchanger is disposed in the second flow channel. The first heat exchanger is formed and operable as an evaporator for cooling and/or dehumidifying an air mass flow, regardless of operating modes, and the second heat exchanger is formed and operable as a condenser/gas cooler for heating an air mass flow, regardless of operating modes. Moreover, an air guide device is disposed between the evaporator and the passenger compartment in the flow direction of air in the first flow channel. In this case, the air guide device is also referred to as a cold-air flap due to the cooled and/or dehumidified air mass flow. An additional air guide device is disposed between the condenser/gas cooler and the passenger compartment in the flow direction of air in the second flow channel. In this case, the additional air guide device is also referred to as a hot-air flap due to the heated air mass flow.

In the case where refrigerant such as R134a is used, when the refrigerant is liquefied under the subcritical operation of the refrigerant circulation system or the specific surrounding environment in which carbon dioxide is used, the heat exchanger is referred to as a condenser. Partial heat transfer is conducted at a certain temperature. During supercritical operation or supercritical heat dissipation in the heat exchanger, the temperature of refrigerant is uniformly reduced. In this case, the heat exchanger is referred to as a gas cooler. The supercritical operation may occur, for example in the specific surrounding environment or operating mode of the refrigerant circulation system in which carbon dioxide is used as refrigerant. The term “condenser” used in the following specification also means a gas cooler.

According to the concept of the present invention, the air guide device disposed in the first flow channel consists of multiple parts such as at least two members. In this case, the members are respectively assigned to air channels extending to the passenger compartment, are independently controllable, and are movable so as to open or close the respective air channels. The air guide device is preferably formed as a dual cold-air flap. In this case, each member is provided to an air distribution system in the vehicle or one side of the passenger compartment. Different sides mean, for example so-called zones, such as a driver's seat and a passenger's seat, and these zones are individually controllable by the air-conditioning system according to the present invention.

The air-conditioning system is a so-called multi-zone air-conditioning system, in particular an air-conditioning system having two zones, and is configured such that different operating modes are adjusted only through the control of air guide devices.

According to an improvement of the present invention, the air guide device disposed in the second flow channel consists of multiple parts such as at least two members. In this case, the members are respectively assigned to air channels extending to the passenger compartment, are independently controllable, and are movable so as to open or close the respective air channels. The air guide device is preferably formed as a dual hot-air flap. In this case, each member is provided to an air distribution system in the vehicle or one side of the passenger compartment, e.g. a driver's seat or a passenger's seat. These different zones are individually controllable by the air-conditioning system.

By differently using the air guide devices and the zones, it is possible to completely block or close, for example a passenger's seat. The blockage requires the lower output of the air-conditioning system, compared to when using all zones. This is particularly because a lower air mass flow may be transferred to decrease the output of the blower, the refrigerant circulation system has a lower heating capacity or cooling capacity to heat or cool the air mass flow to be supplied to the passenger compartment, and the compressor having lower output is usable.

According to a preferred embodiment of the present invention, the multiple members of the air guide device are continuously movable between two end positions in a fully closed state and a fully opened state. In this case, the positions of the respective members are preferably controlled by a controller.

According to another preferred embodiment of the present invention, the condenser may be configured such that a portion of the heat transfer surface thereof is arranged in both the first flow channel and the second flow channel. In this case, the ratio of the heat transfer surface arranged in the second flow channel, the ratio being required for each operating mode in particular for the reheating mode, is adjustable in such a manner that air is supplied to the heat transfer surface by air guide devices. The air guide devices are arranged so as to be movable or fixable.

Preferably, the air mass flows, which are conditioned when excessively flowing the first and/or second flow channel and the evaporator and/or condenser, may be guided to the passenger compartment and/or the outside of the vehicle through flow paths. In this case, the first flow channel is preferably formed next to the evaporator in the flow direction of air in such a manner that the first flow channel is divided into a cold-air flow path with the cold-air flap and a cold-air flow path with an additional air guide device. Therefore, the air mass flow conditioned through the first flow channel may be divided into partial air mass flows at positions of the air guide devices. In this case, the first partial air mass flow may be guided through the cold-air flow path leading to the passenger compartment, and the second partial air mass flow may be guided through the cold-air flow path leading to the outside of the housing. The second flow channel is preferably formed next to the condenser in the flow direction of air in such a manner that the second flow channel is divided into a hot-air flow path with the hot-air flap and a hot-air flow path with an additional air guide device. Therefore, the air mass flow conditioned through the second flow channel may be divided into partial air mass flows at positions of the air guide devices. In this case, the first partial air mass flow may be guided through the hot-air flow path leading to the passenger compartment, and the second partial air mass flow may be guided through the hot-air flow path leading to the outside of the housing.

Flow channels are preferably formed so as to be supplied with fresh air introduced from the outside, recirculation air in the passenger compartment, or a mixture of the fresh air and the recirculation air. The flow channels are preferably arranged such that the main flow directions of air are therein aligned parallel to each other to be directed in one common direction. The directions of air mass flows, which are at least directed toward the passenger compartment, are actually equal to each other.

According to a further preferred embodiment of the present invention, at least one blower is provided, and the blower transfers an air mass flow through the air-conditioning system. According to an improvement of the present invention, two blowers are provided so as to be independently operable. In this case, the first blower transfers an air mass flow to the first flow channel, and the second blower transfers an air mass flow to the second flow channel.

In accordance with another aspect of the present invention, the above and other objects can be accomplished by the provision of a method of operating an air-conditioning system for conditioning air in a vehicle passenger compartment, for operating in both a cooling system mode and a heat pump mode for cooling and heating air in a vehicle passenger compartment and for operating in a reheating mode. The method includes the following steps of:
transferring at least two air mass flows in the housing of the air-conditioning system;
cooling and/or dehumidifying a first air mass flow when the first air mass flow excessively flows in the evaporator of the refrigerant circulation system;
dividing the cooled and/or dehumidified air mass flow into at least two partial cold-air mass flows, wherein the air mass flow is divided at a ratio of 0% to 100%, and the partial cold-air mass flows are guided to different discharge ports in the passenger compartment;
heating a second air mass flow when the second air mass flow excessively flows in the condenser of the refrigerant circulation system, the second air mass flow being guided to different discharge ports in the passenger compartment;
mixing at least one of the cooled and/or dehumidified partial cold-air mass flows with at least a portion of the heated air mass flow; and
introducing the air mass flows into the passenger compartment.

According to a preferred embodiment of the present invention, the first air mass flow, which is cooled and/or dehumidified when excessively flowing in the evaporator, is divided, at a ratio of 0% to 100%, into a partial air mass flow guided to the outside and an air mass flow divided into at least two additional partial cold-air mass flows.

According to a preferred embodiment of the present invention, the method of operating the air-conditioning system during operation in the reheating mode includes the following steps of:
dividing at least one of at least two partial cold-air mass flows into a first partial cold-air mass flow for reheating and a second partial cold-air mass flow, at a ratio of 0% to 100%, wherein the ratio of the partial cold-air mass flow for reheating is greater than 0%;
heating the first partial cold-air mass flow for reheating when the first partial cold-air mass flow excessively flows in the condenser of the refrigerant circulation system;
mixing the reheated first partial cold-air mass flow with the pre-conditioned second partial cold-air mass flow; and
introducing the mixed air mass flow to the passenger compartment, wherein the second partial air mass flow, which is heated when excessively flowing in the condenser, is at least proportionally guided to different discharge ports in the passenger compartment and/or to the outside.

According to an improvement of the present invention, the second air mass flow, which is heated when excessively flowing in the condenser, is divided into at least two partial air mass flows. In this case, the air mass flow is divided respectively at a ratio of 0% to 100%. The partial air mass flows are guided to different discharge ports in the passenger compartment.

According to a preferred embodiment of the present invention, the second air mass flow, which is heated when excessively flowing in the condenser, is divided, at a ratio of 0% to 100%, into a partial air mass flow guided to the outside and an air mass flow guided to the passenger compartment.

Consequently, the present invention has the following additional advantages:
individually adjustable temperatures to be suitable for various zones in a vehicle passenger compartment, and thus increased and individually adjustable comfort for occupants;
an increase in efficiency during the operation of an air-conditioning system by blocking zones, to which no conditioned air is supplied, as intended, the increase in efficiency being possible by the following:
a reduction in an amount of air to be transferred and conditioned; and
a reduction in demand for energy; and
a reduction in output required to increase the temperature in the passenger compartment through air flow rate regulation suitable for the purpose in flow channels.

### BRIEF DESCRIPTION OF DRAWINGS

The above and other objects, features and other advantages of the present invention will be more clearly understood from the following detailed description taken in conjunction with the accompanying drawings, in which:

FIG. 1A to 1C are views illustrating an air-conditioning system having two flow channels, air guide devices, an evaporator, and a condenser during operation in different operating modes;

FIG. 2A is a view illustrating a multi-zone air-conditioning system having flow channels, air guide devices, in particular a cold-air flap and a hot-air flap, an evaporator, and a condenser;

FIG. 2B is a cross-sectional view illustrating a multi-zone air-conditioning system having a cold-air flap divided into two parts and a hot-air flap divided into two parts; and

FIG. 2C is a cross-sectional view illustrating a multi-zone air-conditioning system having a cold-air flap divided into two parts and a single hot-air flap.

### BEST MODE FOR INVENTION

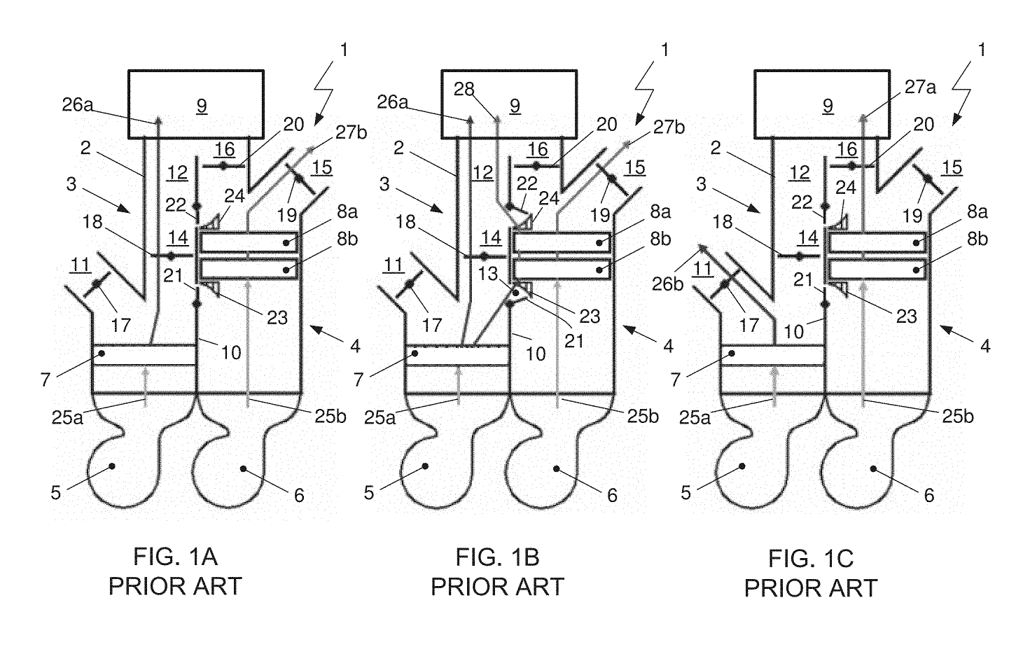

FIGS. 1A to 1C illustrate an air-conditioning system 1 according to the related art, which includes a housing 2 having a first flow channel 3 and a second flow channel 4. In this case, blowers 5, 6 are assigned to the respective flow channels 3, 4, and fresh air introduced from the outside, a recirculation air in a passenger compartment 9, or a mixture thereof may be supplied to the channels 3, 4. FIG. 1A illustrates the air-conditioning system 1 during operation in a cooling system mode, FIG. 1B illustrates the air-conditioning system 1 during operation in a reheating mode, and FIG. 1C illustrates the air-conditioning system 1 during operation in a heat pump mode.

An evaporator 7 is disposed in the first flow channel 3, and a condenser 8a and 8b is disposed in the second flow channel 4. In this case, both are parts of a refrigerant circulation system (not shown) of the air-conditioning system 1, and are formed as heat exchangers to which air is supplied. The condenser may consist of a single part, or may consist of two separated parts as illustrated in the drawings. In this case, the evaporator 7 occupies the flow cross-section of the first flow channel 3. The condenser 8a, 8b is arranged so as to overlap with the flow channels 3, 4, and has two regions. The first region is arranged in the second flow channel 4 so as to cover the overall flow cross-section, and has a higher heat transfer surface than the second region. The second region of the condenser 8a, 8b may be arranged in the first flow channel 3 or in the second flow channel 4, as needed and depending on the operating mode of the air-conditioning system 1. In this case, the second region of the condenser 8a, 8b may be arranged in a flow path 13 of the first flow channel 1 (particularly, illustrated in FIG. 1B), and the second region occupies the overall flow cross-section of the flow path 13, the size of which is variable.

The first and second flow channels 3, 4 are separated from each other by a partition wall 10, two additional air guide devices 21, 22 as movable flaps, and stationary air guide devices 23, 24 as air baffles. The matched air guide devices 21, 22, and the air baffles 23, 24, which are aligned parallel to the partition wall 10 in the cooling system mode of FIG. 1A and in the heat pump mode of FIG. 1C, form air guide devices for the condenser 8a, 8b. The air guide devices 21, 22 and the air baffles 23, 24 serve to prevent the air mass flow in the first flow channel 3 and the air mass flow in the second flow channel 4, which are cooled and conditioned when the air flows through the evaporator 7, from mixing with each other. The air baffles 23, 24, which protrude into the second flow channel 4 and are distant from the partition wall 10, each have an increased length. The more the air baffles 23, 24 are distant from the partition wall 10, the greater the respective length of each of the air baffles 23, 24. In this case, the lengths of the air baffles 23, 24 increase in such a manner that the overall arrangement ends of the air baffles 23, 24 form two recessed surfaces. The surfaces are curved respectively in the same manner to draw circular arcs about the axes aligned parallel to the surfaces. The centers of the circular arcs refer to axes, respectively, and the rectangular surfaces are curved about the axes. In this case, the axes correspond to the rotary axes of the movable air guide devices 21, 22. The radii of the surfaces, which are curved in the form of circular arc, correspond to the longitudinal extension parts of the air guide devices 21, 22. That is, the radii of the surfaces correspond to the extension parts of the movable air guide devices 21, 22 in the direction of the mass flows of air passing through the flow channels 3, 4.

The pivotable air guide devices 21, 22 are aligned such that the side edges thereof, which are distant from the rotary axes and face each other, are concavely curved and directed toward surfaces that stretch from the ends of the air baffles 23, 24. For free movement of the air guide devices 21, 22, a gap having a minimum width is present between the side edge of each of the air guide devices 21, 22 and the associated surface. The gap has no influence on or has a slight influence on the mass flow of air. The air guide devices 21, 22 simultaneously rotate about the respective rotary axes in opposite directions, thereby enabling the ratio between the regions of the condenser 8a, 8b to be adjusted in the first and second flow channels 3, 4. In this case, the regions of the condenser 8a, 8b may be continuously divided. In order to cause the air mass flow to flow along the sequential flow surface, the air guide devices 21, 22 rotate, and are then aligned such that the side edges thereof, which are parallel to the rotary axes and are distant therefrom to face each other, face the ends of the air baffles 23, 24. The leakage flow, which occurs at the intermediate positions of the air guide devices 21, 22 relative to the air baffles 23, 24, is negligible. The intermediate positions mean positions of the air guide devices 21, 22 in which the side edges of the air guide devices 21, 22 do not exactly face the edges of the air baffles 23, 24, but rather are disposed between both air baffles 23, 24.

Air mass flows having different rates are supplied to the first flow channel 3 with the evaporator 7 and the second flow channel 4 with the condenser 8a, 8b, and the first and second flow channels 3, 4 enable the air mass flows to rapidly respond to the changed operating conditions. Therefore, the individually adjustable blowers 5, 6 bring about the advantageous dynamics of the air-conditioning system 1. The blower 5 in the first flow channel 3 guides air, which is introduced in a flow direction 25a, as an air mass flow, to the evaporator 7. The air mass flow is cooled and/or dehumidified when excessively flowing in the evaporator 7. The cold-air mass flow discharged from the evaporator 7 is divided, at a required ratio, into a partial air mass flow, which flows to the outside through a cold-air flow path 11 referred to as an exhaust channel 11 in a flow direction 26b, and a partial air mass flow, which flows to the passenger compartment 9 through a cold-air flow path 12 in a flow direction 26a, or is entirely assigned to one of the cold-air flow paths 11, 12. The cold-air mass flow is divided by air guide devices 17, 18 as flaps.

Similar to the blower 5, the blower 6 sucks air in a flow direction 25b and then guides the sucked air, as an air mass flow, to the condenser 8a, 8b. The air mass flow is heated when excessively flowing in the condenser 8a, 8b. The hot-air mass flow discharged from the condenser 8a, 8b is divided, at a required ratio, into a partial air mass flow, which flows to the outside through a hot-air flow path 15 in a flow direction 27b, and a partial air mass flow, which flows to the passenger compartment 9 through a hot-air flow path 16 in a flow direction 27a, or is entirely assigned to one of the hot-air flow paths 15, 16. The hot-air mass flow is divided by air guide devices 19, 20 as flaps.

When the air-conditioning system 1 operates in the cooling system mode, i.e. when the air-conditioning system 1 cools air to be supplied to the passenger compartment 9, as illustrated in FIG. 1A, the air guide device 18 is opened. The air guide devices 21, 22 are aligned in a manner that is flush with the partition wall 10 so as to close a flow path 13 (see FIG. 1B) extending through the region of the condenser 8a, 8b. As a result, the entirety of air mass flow passes and flows by the condenser 8a, 8b in the flow direction 26a while the cold-air flow path 11 is closed, and is guided to the passenger compartment 9 through the cold-air flow path 12. The air mass flow passing through the first flow channel 3 is a bypass flow, and is guided through a bypass channel 14 which bypasses around the condenser 8a, 8b. The air guide devices 19, 20 are aligned such that the air mass flow is guided to the outside through the hot-air flow path 15 in the flow direction 27b while the hot-air flow path 16 leading to the passenger compartment 9 is closed. The blower 5 transfers air to the evaporator 7 through the first flow channel 3 in the flow direction 25a. The air is cooled and dehumidified, and then flows to the passenger compartment 9 through the cold-air flow path 12 in the flow direction 26a. The blower 6 transfers air to the condenser 8a, 8b in the flow direction 25b in the second flow channel 4. The air is heated, and then flows to the outside through the hot-air flow path 15 in the flow direction 27b.

When the air-conditioning system 1 operates in the heat pump mode, i.e. when the air-conditioning system 1 heats air to be supplied to the passenger compartment 9, as illustrated in FIG. 1C, the air guide devices 17, 20 are opened. As a result, the air mass flow transferred through the first flow channel 3 is guided to the outside through the cold-air flow path 11 in the flow direction 26b, while the bypass channel 14 is closed by the air guide device 18. The air guide devices 21, 22 are aligned in a manner that is flush with the partition wall 10, with the consequence that the flow path 13 is also closed. The air mass flow transferred through the second flow channel 4 is guided to the passenger compartment 9 through the hot-air flow path 16 in the flow direction 27a, while the hot-air flow path 15 is closed by the air guide device 19. The blower 5 transfers air to the evaporator 7 through the first flow channel 3 in the flow direction 25a. The air is cooled, and then flows to outside through the cold-air flow path 11 in the flow direction 26b. The blower 6 transfers air to the condenser 8a, 8b through the second flow channel 4 in the flow direction 25b. The air is heated, and then reaches the passenger compartment 9 through the hot-air flow path 16 in the flow direction 27a.

When the air-conditioning system 1 operates in the reheating mode, i.e. when the air-conditioning system 1 cools and/or dehumidifies and reheats air to be supplied to the passenger compartment 9, as illustrated in FIG. 1B, the air guide devices 17, 18, 19, 20, 21, 22 are arranged at different positions between a fully opened state and a fully closed state, as needed. The positions of the air guide devices 17, 18, 21, 22, and the air mass flow to be heated by the rotational speed of the blower 5 are changed. The region of the condenser 8a, 8b, which is arranged in the flow path 13, is preferentially usable during operation in the reheating mode.

The air guide devices 21, 22 are aligned such that the flow path 13 extending through the region of the condenser 8a, 8b is opened. As a result, the air mass flow, which flows through the first flow channel 3 and is a first partial air mass flow, passes by the condenser 8a, 8b in the flow direction 26a, and is then guided to the cold-air flow path 12 through the bypass channel 14, while a second partial air mass flow is reheated when excessively flowing in the region of the condenser 8a, 8b. Although the cold-air flow path 11 is closed, it may be opened in an alternative operating mode (not shown). Consequently, the air mass flow, which is guided through the first flow channel 3 and is the first partial air mass flow/bypass flow, is guided through the bypass channel 14 which bypasses the condenser 8a, 8b, and the second partial air mass flow is guided through the flow path 13 in a flow direction 28, and is then reheated. When the air guide devices 18, 21, 22 are opened, the partial air mass flow, which is reheated when excessively flowing in the condenser 8a, 8b, is mixed with a partial air mass flow of the cold-air mass flow in the cold-air flow path 12. The partial air mass flow passing through the first flow channel 3 may be adjusted through the adjustment of the air guide device 17, the power supply of the blower 5, and the rotational speed of the blower 5. When the air guide device 17 is opened, the partial air mass flow passing through the first flow channel 3 is reduced depending on the position of the air guide device 17. The first partial air mass flow having a cold-air mass flow temperature and the heated second partial air mass flow are mixed in the cold-air flow path 12 to be an air mass flow having the same temperature, and the air mass flow is supplied to the passenger compartment 9 in a flow direction 29.

When the air guide device 18 is closed, the air mass flow, which is reheated when excessively flowing in the condenser 8a, 8b, is guided to the passenger compartment 9 in the state in which it is not mixed. Moreover, the partial cold-air mass flow, which is conditioned when excessively flowing in the evaporator 7, may be guided to the outside through the air guide device 17 and the cold-air flow path 11 which are opened.

The air guide devices 19, 20 are aligned such that the air mass flow is guided to the outside through the hot-air flow path 15 in the flow direction 27b while the hot-air flow path 16 leading to the passenger compartment 9 is closed. The blower 5 transfers air to the evaporator 7 through the first flow channel 3 in the flow direction 25a. After the air is cooled and dehumidified, it is divided into two partial air mass flows. The partial air mass flows flow to the cold-air flow path 12 through the bypass channel 14 and the flow path 13 in the flow direction 26a, and are mixed so as to flow to the passenger compartment 9. The blower 6 transfers air to the condenser 8a, 8b in the flow direction 25b in the second flow channel 4. The air is heated, and then flows to the outside through the hot-air flow path 15 in the flow direction 27b.

The two pairs of flaps 17, 18, 19, 20 are each connected by one dynamic device, and may be adjusted by a single drive device. Alternatively, the air guide devices 17, 18, 19, 20 as flaps may consist of a single flap.

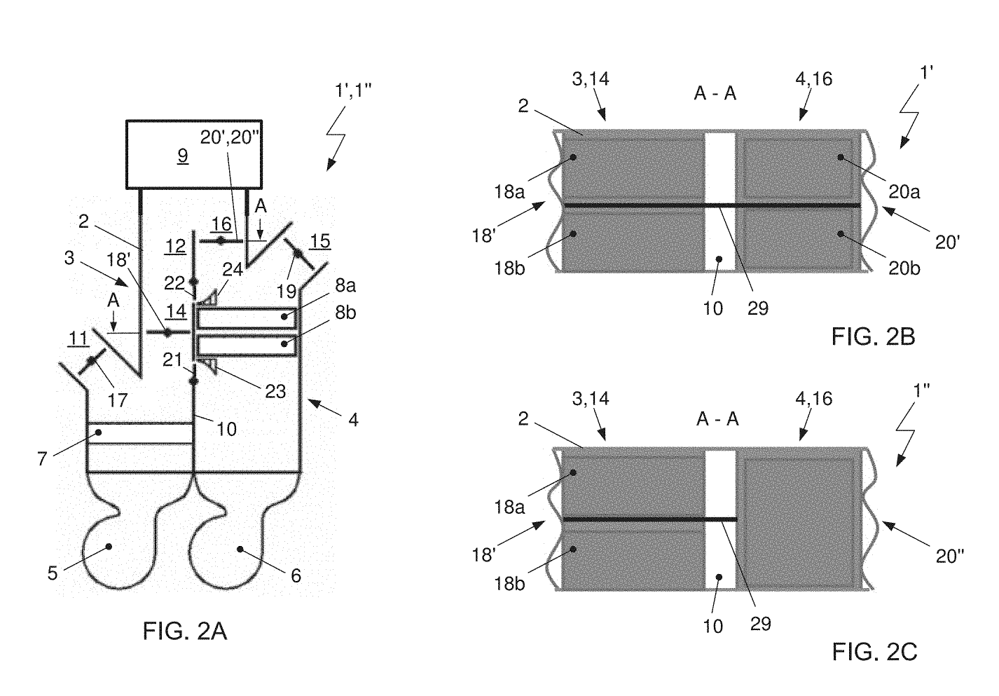

FIG. 2A illustrates an air-conditioning system 1′ or 1″ having multiple zones, in particular two zones, the air-conditioning system includes two flow channels 3, 4, air guide devices 17, 18′, 19, 20′, 20″, 21, 22, 23, 24, in particular a cold-air flap 18′ and a hot-air flap 20′, 20″, an evaporator 7, and a condenser 8a, 8b. In this case, the air-conditioning system 1′ or 1″ basically corresponds to the air-conditioning system 1 illustrated in FIGS. 1A to 1C, in terms of functions and configurations. The air-conditioning system 1′, 1″ having at least two zones differs from the air-conditioning system 1 having one zone illustrated in FIGS. 1A to 1C in that the cold-air flap 18′ as an air guided device 18′ is disposed in a bypass channel 14 and a hot-air flap 20′, 20″ as an air guided device 20′, 20″ is disposed in a hot-air flow path 16, as illustrated in FIGS. 2A to 2C.

FIG. 2B is a cross-sectional view illustrating an air-conditioning system 1′ which has a cold-air flap 18′ divided into two parts and a hot-air flap 20′ divided into two parts. A bypass channel 14 in first flow channel 3 is opened or closed by the cold-air flap 18′. The bypass channel 14 is formed so as to be limited by a housing 2 and a partition wall 10. A hot-air flow path 16 is opened or closed by the hot-air flap 20′ in a second flow channel 4. The hot-air flow path 16 is also formed so as to be limited by the housing 2 and the partition wall 10.

The cold-air flap 18′ is subdivided into a first member 18a and a second member 18b in the region of a separation member 29, and the first and second members may be controlled and moved independently. The hot-air flap 20′ is subdivided into a first member 20a and a second member 20b in the region of the separation member 29. The first and second members 20a and 20b of the hot-air flap 20′ may be controlled and moved independently. By the subdivision of the cold-air flap 18′, which is present in the bypass channel 14 or the cold-air flow path 12, and of the hot-air flap 20′, which is present in the hot-air flow path 16, an air mass flow, which flows through the cold-air flow path 12 or the hot-air flow path 16, is branched behind the corresponding member 18a, 18b of the cold-air flap 18′ or the corresponding member 20a, 20b of the hot-air flap 20′ in the flow direction of the air mass flow in the associated zone of the air-conditioning system 1′, and is then guided to corresponding zones leading to a passenger compartment 9 through an air channel system. Each position of the individual members 18a, 18b, 20a, 20b, and each of predetermined air mass flows, which flow to the respective zones through the channels of the channel system, are controlled by a controller. In this case, the members 18a, 18b, 20a, 20b may be continuously adjusted between end positions in a fully closed state and a fully opened state. As a result, each desired temperature of air, which is supplied from corresponding discharge ports assigned to the air channels, may be adjusted between the temperature of the air mass flow in the cold-air flow path 12 and the temperature of the air mass flow in the hot-air flow path 16.

Consequentially, the members 18a, 18b of the cold-air flap 18′ and the members 20a, 20b of the hot-air flap 20′ are formed such that channels subsequent to the members 18a, 18b, 20a, 20b in the flow direction of air are fully closed and sealed, thereby enabling the individual zones of the air-conditioning system 1′ to be blocked at the air side thereof. In addition, the air-conditioning system 1′ may be operated with the use of minimum energy.

FIG. 2C is a cross-sectional view illustrating an air-conditioning system 1″ which has a cold-air flap 18″ divided into two parts and a single hot-air flap 20″.

The air-conditioning system 1″ differs from the air-conditioning system 1′ illustrated in FIG. 2B in that the hot-air flap 20″ consists of a single part.

Accordingly, in the air-conditioning system 1″ illustrated in FIG. 2C, only the cold-air flap 18″ for subdividing a cold-air flow path 12 consists of two members 18a, 18b. The single hot-air flap 20″, which is not subdivided, is disposed in a hot-air flow path 16. In this case, a condenser 8a, 8b is set at a desired temperature as needed and depending on operating modes, and the desired temperature is determined by the maximum target value of each individual zone. In other zones, a cold air flowing through the cold-air flow path 12 and a cold air flowing through the subdivided cold-air flap 18 are mixed so as to correspond to a required temperature, thereby enabling air having a correspondingly adjusted temperature to be supplied from individual discharge ports in the zones.

[Description of Reference Numerals]

1: air-conditioning system having one zone

1′, 1″: air-conditioning system having multiple zones

2: housing

3: first flow channel

4: second flow channel

5, 6: blower

7: evaporator

8a, 8b: condenser/gas cooler

9: passenger compartment

10: partition wall

11: cold-air flow path, exhaust channel

12: cold-air flow path

13: flow path in first flow channel (3)

14: bypass channel in first flow channel (3)

15: hot-air flow path, exhaust channel

16: hot-air flow path

17: air guide device/flap in cold-air flow path (11)

18, 18′: air guide device/flap in bypass channel (14), cold-air flap

18a, 18b: member of cold-air flap

19: air guide device/flap in hot-air flow path (15)

20, 20′, 20″: air guide device/flap in hot-air flow path (16), hot-air flap

20a, 20b: member of hot-air flap

21, 22: air guide device/flap between flow channels (3, 4) for inflow and outflow in inlet/outlet of condenser (8a, 8b)-flow path (13)

23, 24: stationary air guide device, air baffle

25a, 25b: flow direction of sucked air

26a, 26b: flow direction of cold air

27a, 27b: flow direction of hot air

28: flow direction of dehumidified hot-air

29: separation member

1. An air-conditioning system for conditioning air in a vehicle passenger compartment, the air-conditioning system configured to operate in a cooling system mode for cooling air to be supplied to the passenger compartment, in a heat pump mode for heating air to be supplied to the passenger compartment, and to operate in a reheating mode, the air-conditioning system comprising:
a housing having a first flow channel and a second flow channel for guiding air;
a refrigerant circulation system having at least two heat exchangers, a first one of the heat exchangers disposed in the first flow channel, a second one of the heat exchangers disposed in the second flow channel, wherein the first one of the heat exchangers is operable as an evaporator regardless of an operating mode and the second one of the heat exchangers is operable as a condenser/gas cooler regardless of the operating mode;
a first air guide device disposed between the the first one of the heat exchangers and the passenger compartment in the first flow channel; and
a second air guide device disposed between the condenser/gas cooler and the passenger compartment in the second flow channel, wherein the first air guide device disposed in the first flow channel includes at least two members respectively disposed in air channels of the first flow channel extending to the passenger compartment, independently controllable, and movable to open or close the respective air channels of the first flow channel.

2. The air-conditioning system according to claim 1, wherein the second air guide device disposed in the second flow channel includes at least two members respectively disposed in air channels of the second flow channel extending to the passenger compartment, independently controllable, and movable to open or close the respective air channels of the second flow channel.

3. The air-conditioning system according to claim 2, wherein the at least two members of the first air guide device and the at least two members of the second air guide device are continuously movable between a fully closed state and a fully opened state.

4. The air-conditioning system according to claim 1, wherein a portion of a heat transfer surface of the second one of the heat exchangers is arranged in both the first flow channel and the second flow channel, and air supplied to the portion of the heat transfer surface is adjustable for each operating mode by a plurality of air guide devices.

5. The air-conditioning system according to claim 1, wherein the first flow channel downstream of the evaporator in a flow direction of air is divided into a first cold-air flow path with the first air guide device and a second cold-air flow path with a third air guide device, thereby enabling an air mass flow conditioned through the first flow channel to be divided into partial air mass flows at the first air guide device and the third air guide device, a first partial air mass flow guidable to the passenger compartment through the first cold-air flow path and a second partial air mass flow guidable out of the housing through the second cold-air flow path.

6. The air-conditioning system according to claim 1, wherein the second flow channel downstream of the condenser in a flow direction of air is divided into a first hot-air flow path with the second air guide device and a second hot-air flow path with a second hot-air flow path air guide device, thereby enabling an air mass flow conditioned through the second flow channel to be divided into partial air mass flows at the second air guide device and the second hot-air flow path air guide device, a first partial air mass flow guidable to the passenger compartment through the first hot-air flow path and a second partial air mass flow guidable out of the housing through the second hot-air flow path.

7. A method of operating an air-conditioning system in both a cooling system mode and a heat pump mode for cooling and heating air in a vehicle passenger compartment and for operating in a reheating mode, the method comprising the steps of:
providing the air-conditioning system comprising:
a housing with a first flow channel and a second flow channel for guiding air;
a refrigerant circulation system having an evaporator and a condenser, the evaporator disposed in the first flow channel and the condenser disposed in the second flow channel;
a first air guide device disposed between the evaporator and the passenger compartment in the first flow channel; and
a second air guide device disposed between the condenser and the passenger compartment in the second flow channel, wherein the first air guide device includes at least two independently controllable members respectively disposed in air channels of the first flow channel extending to the passenger compartment which are movable to open or close the respective air channels of the first flow channel.
transferring at least two air mass flows in the housing of the air-conditioning system;
cooling and/or dehumidifying a first air mass flow of the at least two air mass flows when the first air mass flow excessively flows in the evaporator of the refrigerant circulation system;
dividing the cooled and/or dehumidified air mass flow into at least two partial cold-air mass flows, wherein the air mass flow is divided at a ratio of 0% to 100%, and the partial cold-air mass flows are guided to different discharge ports in the passenger compartment;
heating a second air mass flow of the at least two air mass flows when the second air mass flow excessively flows in the condenser of the refrigerant circulation system, the second air mass flow being guided to different discharge ports in the passenger compartment;
mixing at least one of the cooled and/or dehumidified partial cold-air mass flows with at least a portion of the second air mass flow; and
introducing the two air mass flows into the passenger compartment.

8. The method according to claim 7, wherein the first air mass flow is divided, at a ratio of 0% to 100%, into a partial air mass flow guided out of the housing and an air mass flow divided into at least two additional partial cold-air mass flows.

9. The method according to claim 7, wherein the second air mass flow is divided into at least two partial air mass flows at a ratio of 0% to 100%, and the partial air mass flows are guided to different discharge ports in the passenger compartment.

10. The method according to claim 7, wherein the second air mass flow is divided, at a ratio of 0% to 100%, into a partial air mass flow guided to the outside-out of the housing and an air mass flow guided to the passenger compartment.
